(19) United States
(12) Patent Application Publication
(10) Pub. No.: US 2003/0113421 A1
(43) Pub. Date: Jun. 19, 2003

(54) Synergistic combinations of natural of compounds that control decay of fruits and vegetables and reduce contamination by foodborne human pathogens

(76) Inventors: Charles L. Wilson, Shepherdstown, WV (US); Ahmed El Ghaouth, Frederick, MD (US); Michael E. Wisniewski, Shepherdstown, WV (US)

Correspondence Address: USDA, ARS, OTT, 5601 SUNNYSIDE AVE, RM 4-1159, BELTSVILLE, MD, 20705-5131, US

(21) Appl. No.: 09/912,448

(22) Filed: Jul. 26, 2001

(51) Int. Cl. A23K 1/00

(52) U.S. Cl. 426/326

(57) ABSTRACT

Plant essential oils and chitosan salts were tested individually and in combination against a postharvest pathogen Botrytis cinerea and two foodborne human pathogens Escherichia coli and Listeria monocytogenes. Four essential oils (cinnamon, allspice, savory, red thyme) in combination with two chitosan salts (chitosan sorbate and chitosan propionate) demonstrated synergistic antimicrobial activity against all three organisms. The synergistic combinations of essential oils and chitosan salts also demonstrated an eradicant activity against E. coli on apple disks previously inoculated with the organism. Synergistic combinations of essential oils and chitosan salts hold promise of giving superior control of both postharvest decay organisms and foodborne human pathogens.

### BACKGROUND OF THE INVENTION

1. Field of the Invention

This invention relates to synergistic combinations of natural antimicrobial compounds that are effective against postharvest and foodborne human pathogens.

2. Description of the Relevant Art

Postharvest decay and contamination of fruits and vegetables with foodborne pathogens have been and continue to be of major concern to the fruit and vegetable industry. Conservative estimates place U.S. and Canadian losses of fruits and vegetables from postharvest decay at around 25% of the harvested crops. This problem has been further compounded by the risk of contamination of fresh and processed fruits and vegetables with foodborne pathogens. Several pathogenic bacteria such as Salmonella spp, Listeria monocytogenes, Clostridium botulinum, and Escherichia coli 0157:H7 have been shown to occur at base levels on the outer surfaces of a wide variety of harvested commodities (1988. Microorganisms in Foods: Application of the Hazard Analysis Critical Control Point (HACCP) System to Insure Microbiological Safety and Quality, Silliker et al., Eds. Blackwell Scientific Publications, Oxford, England). Recent outbreaks of foodborne illness associated with consumption of fresh horticultural products and non-pasteurized fruit juices have weakened consumers confidence in the wholesomeness of fresh produce (Fairchild et al. 1990. The Packer 33: 1-7; Schwartz et al. 1995. The Packer 27: 6; Wells et al. 1997. Plant Dis. 81: 867-872; Parish et al. 1998. J. Food Protection 61: 280-284).

Presently, chlorinated washes in conjunction with proper refrigeration, stringent sanitation, and synthetic fungicides are the primary means of controlling foodborne pathogens and postharvest decay. However, the carcinogenicity of trihalomethanes and the possible regulatory restriction of chlorine present major challenges for the fresh produce industry to find safe alternatives. Similar public concern has been raised regarding fungicide safety. As a result, a number of key postharvest fungicides have been recently banned or are undergoing critical re-registration. In addition, some of the fungicides registered for postharvest use, particularly benzimidazole, are becoming ineffective because of the development of fungicide-resistant strains of postharvest pathogens (Spotts et al. 1986. Plant Dis. 70: 106-108; Eckert, J. W. 1991. In: Role of Chemical Fungicides and Biological Agents in Postharvest Disease Control. Proceedings of the Workshop on Biological Control of Postharvest Diseases of Fruits and Vegetables, Shepherdstown, W. Va., USA, Sep. 12-14, 1990, U.S.D.A. and A.R.S. Publication Vol. 92, page 310.). Thus, it has become apparent that new, safe methodologies are needed to reduce both decay and contamination of our food supply by foodborne human pathogens.

The use of natural plant- and animal-derived antimicrobials, i.e., compounds that are antibacterial and antifungal, as alternatives for the control of foodborne human and plant pathogens provides an attractive means of attacking problems resulting from the contamination of our food with microorganisms. A variety of natural plant compounds including spices, herbs, essential oils, and volatile substances have been shown to suppress the growth of food-poisoning bacteria (Bowles et al. 1993. J. Food Protection 56: 795-800; Deans et al. 1987. Int. J. Food Microbiol. 5: 165-180; Aktug et al. 1986. Int. J. Food Microbiol. 3: 349-353).

In vitro inhibition of the growth of major postharvest pathogens and the reduction of fruit decay was also observed with several essential oils, volatile substances, and plant extracts (Wilson et al. 1987. Plant Dis. 71: 316-319; Wilson et al. 1997. Plant Dis. 81: 204-210; Pesis et al. 1993. J. Plant Physiol. 142: 717-721; Sholberg et al. 1991. J. Canad. Inst. Food Sci. Tech. 2: 273-276; Mattheis et al. 1993. Plant Dis. 77: 810-814; Vaugh et al. 1993. J. Food Sci. 58: 793-796). Also, the inhibition of the growth of foodborne pathogens has been reported with bacteriocins (Fowler et al. 1990. Antibiotics-nisin. In: Food Preservatives, Russel and Gould, Eds. AVI Publishing, New York; Motlagh, A. 1991. Ph.D. Thesis, Univ. Wyoming, Laramie, Wyo.; 1992. Food Biopreservatives of Microbial Origin, Ray and Daeschel, Eds. CRC Press, New York), with organic acids (Ray, B. 1992. Diacetyl of Lactic Bacteria as a Food Biopreservative. In: Food Biopreservatives of Microbial Origin, supra; Arora et al. 1991. Handbook of Applied Mycology Vol. 3. Marcel Dekker, Inc., New York. 621 pages; Al Zaemey et al. 1993. Mycolog. Res. 97: 1463-1468; Sholberg et al. 1995. Hort. Sci. 30: 1271-1275), and with chitosan (Hadwiger et al. 1980. Plant Physiol. 66: 205-211; El Ghaouth et al. 1992. Phytopath. 82: 398-402). Some of these compounds (bacteriocins and organic acids) are also used commercially to control food spoilage. Most current available data provide only fragmented information on the effectiveness of combinations of naturally-occurring antimicrobial compounds and on their effect on both postharvest and foodborne pathogens. Development of synergistic combinations of natural compounds can add a new dimension to their use as food preservatives, enhancing their effectiveness for stability, low toxicity, availability, and broad utility.

### SUMMARY OF THE INVENTION

We have discovered naturally-occurring compounds that are both antifungal and bactericidal and combinations of particular natural compounds that can be used synergistically to control both major postharvest pathogens and foodborne pathogens.

In accordance with this discovery, it is an object of the invention to provide a composition of natural compounds that act synergistically and are effective against postharvest pathogens and foodborne pathogens found on fruits and vegetables.

It is a further object of the present invention to provide a method for protecting fruits and vegetables from postharvest pathogens and foodborne pathogens found on fruit and vegetables by applying to the surface of fruits and vegetables a composition of natural compounds that act synergistically and are effective against bacteria and/or fungi.

It is a still further object of the present invention to provide a method for reducing the effects of the overall microbial content of a food product by applying to the surface of fruits and vegetables a composition of natural compounds that act synergistically and are effective for eradicating or inhibiting growth and toxin production of bacteria and fungi found on fruits and vegetables.

An additional object of the present invention is to provide a fruit or vegetable food product having reduced levels of bacterial and/or fungal postharvest pathogens and foodborne pathogens.

Other objects and advantages of the invention will become readily apparent from the following description.

### DETAILED DESCRIPTION OF THE INVENTION

The present invention provides combinations of chitosan salts and essential oils that act synergistically both to protect food products from bacterial and fungal contamination and to eradicate or at least inhibit growth and toxin production in foods contaminated with bacteria and fungi. The present invention relates to effective, inexpensive, and environmentally appropriate compositions and methods for controlling postharvest pathogens and foodborne pathogens, as for example, enterotoxigenic bacteria such as E. coli and L. monocytogenes, on fruits and vegetables.

Food product here refers to a fruit or a vegetable or part of a fruit or vegetable that can be infected or contaminated by postharvest pathogens and foodborne pathogens. The term “food product” encompasses “exposed fresh fruit” and “exposed fresh vegetable” which in its broadest sense includes the tissue normally covered by the skin of the fruit or vegetable which is exposed when the fruit or vegetable is peeled, cut, segmented or otherwise exposed. The tissue is fresh or raw and is preferably in the form of cut or segmented pieces which have not been heat sterilized or blanched. Generally, one or more of any type of fresh vegetable, fruit or nut, for example, may be treated with the present invention. Suitable examples of fruit include apples, apricots, avocado, bananas, blackberries, blueberries, cherries, cranberries, custard apples, dates, durian, figs, grapefruit, grapes, jack fruit, kiwi fruit, lemons, limes, lychee, mandarins, mangosteen, mangoes, melons, nashi, nectarines, oranges, papaya or paw paw, passionfruit, peaches, pears, pineapple, plums, pomegranates, pomelo, raspberries, rhubarb, star fruit, strawberries, tamarillo, and tangerines of any maturity. Any edible nut is also included. Suitable non-limitative examples of vegetables include: potatoes, corn, tomatoes, onions, herbs, squash, beans, peppers, okra, turnips, broccoli, cauliflower, cabbage, carrots, brussels, sprouts, zucchini, radishes, celery, lettuce, and even prepared mixed vegetable salads. Moreover, any fresh vegetable, fruit or nut may be treated with the present invention, whether grown in the ground or grown hydroponically.

As used herein, “foodborne pathogen” refers to a bacterium or a fungus capable of contaminating a fruit or a vegetable and causing disease to humans or animals ingesting said fruit or vegetable.

As used herein, “postharvest pathogen” refers to a bacterium or a fungus capable of infecting a fruit or a vegetable and thereby causing postharvest decay.

As used herein, the term “synergism” is intended to include both an increased spectrum of activity (i.e., greater activity against a broad spectrum of microorganisms), and/or increased efficacy (i.e., greater activity against specific organisms than that predicted by use of either agent alone). The increased antimicrobial and antifungal activity of the synergistic combination permits the use of smaller amounts of each agent thereby decreasing costs and minimizing other problems, e.g., toxicity, solubility, availability. Effectiveness against a broad spectrum of microorganisms broadens the utility of the synergistic product based on its effectiveness in environments containing many and diverse microorganisms which must be controlled.

Chitosan is a semisynthetic derivative of chitin produced by the deacetylation of the nitrogen thereof so as to produce the ammonium salt. Chitosan has been shown to have some mild antifungal activity with regard to particular fungal species; see for example, Hadwiger et al., supra; El Ghaouth et al. 1994. Phytopath. 84: 313-320; El Ghaouth et al., 1992, supra; Allan et al. 1979. Exp. Mycology 3: 285-287; Stossel et al. 1984. Phytopath. 11: 82-90; Kendra et al. 1984. Exp. Mycology 8: 276-281, and Ben-Shalom et al. 1999. U.S. Pat. No. 5,965,545.

The compositions of the invention comprise combinations of chitosan salts and essential oils that act synergistically both to protect food products from bacteria and fungi and to eradicate or inhibit decay and toxin production in foods contaminated with bacteria and fungi. Particular combinations can be screened in vitro in culture medium prior to testing on food products. Culture medium is inoculated with suspensions of bacteria or fungal spores. Chitosan salts, essential oils, or combinations of chitosan salts and essential oils are (1) added to the culture medium prior to inoculation to determine protective effects or (2) added after inoculation to determine inhibitory or eradicant effects.

Generally, the compositions according to the invention usually contain in addition to the active material (chitosan salt and essential oil), one or more solid or liquid vehicles and, optionally, one or more surface-active agents. The solid or liquid vehicles and/or surface-active agents utilized in the compositions of the invention must be acceptable in agriculture; inert and conventional vehicles and conventional surface-active agents can be used. The compositions according to the invention are pharmaceutically-acceptable, i.e., the compositions or components are suitable for use in contact with human tissue without undue toxicity, incompatibility, instability, allergic response, and the like. These compositions cover not only compositions that are ready to be applied to the fruits and vegetables, as for example by means of a suitable device, such as a spray device, but also commercial concentrated compositions which have to be diluted before application to the food product.

In the present account, the term “vehicle” denotes a natural or synthetic, organic or inorganic material with which the active material is combined to facilitate its application on the food product. This vehicle is thus generally inert and it must be agriculturally and pharmaceutically acceptable. The vehicle can be solid as for example, clays, natural or synthetic silicates, resins, and waxes or the vehicle can be liquid, such as water, alcohols, propylene glycol, a vegetable oil or like edible carrier, and the like. An “aqueous solvent” means a water-based solvent, including but not limited to tap water, distilled water, buffers, salt solutions, and the like.

The surface-active agent can be an emulsifying, dispersing, or wetting agent of ionic or nonionic type or a mixture of such surface-active agents. The presence of at least one surface-active agent is generally indispensable when the active material and/or the inert vehicle is /are not soluble in water and the carrier agent for application is water.

These compositions can also contain any kind of other ingredients such as, for example, protective colloids, adhesives, binding agents, chelating agents, thickening agents, thixotropic agents, penetrating agents, stabilizing agents, sequestering agents and the like. The compositions used in the method of the present invention may also contain other additives depending on the intended use for the composition. For example, the compositions may contain anti-foam agents, antioxidants, natural or synthetic seasonings and/or flavors, dyes and/or colorants, vitamins, minerals, nutrients, enzymes, insecticides, deodorants, and mixtures thereof. The amount of such optional additives included in the composition of the present invention may vary over a wide range, although amounts of about 0.1 to 10.0 percent of these compositions are generally satisfactory.

More generally, the chitosan salts and the essential oils can be combined with all the solid or liquid additives corresponding to the conventional formulating techniques.

As forms of liquid compositions or those intended to constitute liquid compositions at the time of application, solutions, in particular water-soluble concentrates, emulsions, suspension concentrates, aerosols, wettable powders (or powder to be sprayed), pastes or gels are included. The composition of the present invention can be presented to the consumer in dry form to be used after it is wetted with water, i.e., water-activated.

These compositions can be delivered from for example, bottles, tubes, pumps, squeeze roamers, bags, wipes, and aerosol containers as e.g., volatiles, foams, mousses, lathers, wipes, and dips.

A composition according to the present invention is most readily used to treat the surface of solid food products. The active materials or combinations may be applied to fruits and vegetables by dipping, spraying, painting, marinating, and/or wiping the surface. In still other embodiments, the composition may be applied as a breading, seasoning rub, glaze, colorant mixture, and the like, the key criteria being that the antimicrobial composition be available to the surface subject to bacterial or fungal degradation and/or contamination. In still other embodiments, the composition may be indirectly placed into contact with the food surface by applying the composition to food packaging and thereafter applying the packaging to the food surface. The optimum amount to be used will depend on the composition of the particular food product to be treated and the method used for applying the composition to the food surface, but can be determined by simple experimentation. It is preferred that the active material or combination be dissolved or dispersed in a vehicle as defined above, at concentrations between 10 and 50% solids. When employing a composition of the invention, the essential ingredients, namely, the essential oils and/or chitosan salts can advantageously be used in amounts ranging from about 3000 ppm to about 10 ppm based on total weight of the food product.

### EXAMPLES

The following examples serve as further description of the invention and methods for practicing the invention. They are not intended as being limiting, rather as providing guidelines on how the invention may be practiced.

### Example 1

### Bacterial and Fungal Cultures

E. coli (Strain #139 HB101/p5G6) was grown at 24° C. for 48 hr in shake-flask cultures of Lennox broth (LB). Bacterial cells were pelleted by centrifugation in a Sorvall RC-58 centrifuge (Dupont Instruments, Wilmington, Del.) at 3000 g for 20 min, resuspended in sterile distilled water, and centrifuged again. The resulting pellets were dispersed in sterile distilled water and the cell concentration was adjusted to 10⁶ CFU per ml using a standard optical density (OD) curve with the OD values of 0.1 and 1 representing viable cell counts of 1×10⁶ and 1×10⁹, respectively. E. coli 015:H7 and L. monocytogenes isolates were grown overnight at 37° C. in trypticase soy broth and brain heart infusion, respectively. The concentration of cells was adjusted to 10⁶ CFU per ml. Botrytis cinerea and Penicillium expansum were isolated from infected fruit and maintained on potato dextrose agar (PDA). A spore suspension was obtained by flooding 2 wk cultures of B. cinerea with sterile distilled water containing 0.1% (v/v) TWEEN 80. Spore counts were determined with a hemacytometer and spore concentrations were adjusted with sterile distilled water to obtain 10⁵ spores per ml.

### Example 2

### Inhibitory Effect of Essential Oils and Chitosan Salts

The object of this experiment was to determine the individual effects of different essential oils and chitosan salts, and the combined effects of chitosan salts with essential oils on the growth of the indicator organism E. coli and on spore germination of B. cinerea. Autoclaved LB broth was amended with sterile solutions of chitosan salts (chitosan propionate and chitosan sorbate, Sigma, St. Louis, Mo.), essential oils (tarragon, basil, peppermint, wintergreen, savory, thyme red, and allspice; Aroma Vera, Cuber City, Calif.), or combinations of chitosan propionate and chitosan sorbate with individual essential oils to obtain a concentration of 0.1% (v/v) and dispensed into sterile test tubes. Tubes of LB amended with different treatments were inoculated either with 10⁶ CFU per ml of E. coli cells or 500 spores of B. cinerea and incubated on a rotary shaker at 24° C. for 24 hr. For each microorganism, four replicate tubes of each treatment were used; each experiment was repeated twice. Botrytis spore germination was determined microscopically. The viable bacterial cell number was counted by surface plating serially diluted samples in triplicate on LB agar medium. Plates were incubated at 24° C. and colonies were counted at 48 hr.

Among seven essential oils that were tested for their antimicrobial activity against both B. cinerea and E. coli, savory, thyme red, and allspice provided the most effective control of both B. cinerea and E. coli. These three completely inhibited spore germination of B. cinerea and substantially reduced the growth of E. Coli (Table 1).

TABLE 1
Effect of essential oils on spore germination of Botrytis cinerea
and growth of Escherichia coli after 48 hr of incubation at 24° C.

% INHIBITION

| Essential Oil | B. cinerea | E. coli |
|---|---|---|
| Control | 0 | 0 |
| Tarragon | 0 | 5 |
| Basil | 0 | 5 |
| Peppermint | 100 | 9 |
| Wintergreen | 100 | 24 |
| Savory | 100 | 80 |
| Thyme Red | 100 | 80 |
| Allspice | 100 | 84 |

The effect of time of exposure on the biostatic or biocidal activity of the most effective essential oils and combinations of chitosan salts with essential oils was also assessed. Sterile 0.1 % solutions of chitosan salts (chitosan propionate and chitosan sorbate), essential oils (cinnamon, savory, thyme red, and allspice), or combinations of chitosan salts with individual essential oils were supplemented with 0.1% of autoclaved LB for E. coli or 0.1% autoclaved PDB for B. cinerea and dispensed into sterile 10 ml test tubes.

Test tube cultures were inoculated either with 10⁶ CFU per ml of E. coli cells or 500 spores of B. cinerea and incubated on a rotary shaker at 24° C. An individual test tube served as one replicate and four replicates were sampled after one and four hr of incubation from each treatment for each microorganism. Botrytis spore germination and the viability of bacterial cells were determined as described above.

In tests of the various essential oil/chitosan salt combinations against spore germination of B. cinerea and growth of E. coli, all four essential oil/chitosan salt combinations completely inhibited spore germination of B. cinerea and growth of E. coli (Table 2).

TABLE 2
Biocidal activity of essential oils and different combinations
of natural compounds on spore germination of
B. cinerea and growth of E. coli after 1 and 4 hr.

| | Inhibition (%) | | Cell Counts (CFU)^{a} | |
|---|---|---|---|---|
| | B. cinerea | | E. coli | |
| Treatments | 1 hr | 4 hr | 1 hr | 4 hr |
| Control | 0 | 0 | TNTC^{b} | TNTC |
| Chitosan sorbate | 0 | 0 | 544 | 181 |
| Chitosan propionate | 0 | 0 | 527 | 191 |
| Cinnamon | 0 | 100 | >600 | >600 |
| Savory | 0 | 0 | >600 | >600 |
| Allspice | 0 | 100 | >600 | >600 |
| Chitosan sorbate + Cinnamon | 100 | 100 | 0 | 0 |
| Chitosan sorbate + Allspice | 100 | 100 | 0 | 0 |
| Chitosan propionate + Savory | 100 | 100 | 0 | 0 |
| Chitosan propionate + Red Thyme | 100 | 100 | 0 | 0 |

^{a}Number of colony forming units (CFU) in 100 μl sample.
^{b}TNTC = Too Numerous To Count.

### Example 3

### Inhibitory Effect of Essential Oils, Chitosan Salts, and Combinations of Essential Oils and Chitosan Salts

The individual effects of various essential oils and chitosan salts, and the combined effects of essential oils and chitosan salts on the growth of the indicator organism E. coli and on the postharvest pathogen B. cinerea were determined. To measure the effects of the various treatments on spore germination of B. cinerea and growth of the E. coli, the essential oils: bay, cinnamon, savory, thyme red, allspice, birch, cloves, carvacrol, and hinokitiol (Aroma Vera, Cuber City, Calif.) and MMW chitosan in acetic, propionic, and sorbic acids were combined together with B. cinerea or E. coli to yield final concentrations of 0.1 to 0.025% for the essential oils and 0.1 to 0.0016% for the chitosan salts. For the assays, 500 spores of B. cinerea were added to each treatment in microtiter dishes or three ml of a 2X concentration of E. coli (i.e., 2×10⁶ CFU/ml) were combined with three ml of a 2X concentration of treatment in a 15 ml centrifuge tube, agitated overnight, and plated after 24 hr onto LB agar plates (100 μl suspension/plate). The surfactant (Triton×100) was present at a final concentration of 0.04%. Similarly, for experiments measuring synergy, combinations of individual essential oils (at non-inhibitory concentrations) and chitosan acetate, chitosan propionate, or chitosan sorbate (at non-inhibitory concentrations) were combined with B. cinerea or E. coli, as described above. Four replicate tubes of each treatment were used; each experiment was repeated twice. The viable bacterial cell number was counted by surface plating serially diluted samples in triplicate on LB agar medium. Plates were incubated at 24° C. and colonies were counted at 48 hr. Botrytis spore germination was determined microscopically.

Effects on E. coli Growth:

Savory, thyme red, and carvacol, tested individually, were the most effective inhibitors of E. coli growth; each, alone, was inhibitory at 0.05% (Table 3). Cinnamon and hinokitiol reduced E. coli growth at 0.075%; no effects were seen at 0.05% or lower. Bay, cloves, allspice, and birch oil were the least effective inhibitors; they only inhibited at the final concentration of 0.1%. No effects were observed at 0.075% or lower.

TABLE 3
Effect of Concentration of Essential Oil on
Growth of E. coli (CFU^{a})

Concentration (% v/v)

| Essential Oil | 0.1 | 0.075 | 0.05 | 0.025 |
|---|---|---|---|---|
| Bay | 13.5 | TNTC | TNTC | TNTC |
| Cinnamon | 0 | 61.5 | TNTC | TNTC |
| Cloves | 0 | TNTC | TNTC | TNTC |
| Allspice | 0 | TNTC | TNTC | TNTC |
| Thyme Red | 0 | 4.5 | 0.5 | TNTC |
| Savory | 11.5 | 0 | 6.0 | TNTC |
| Birch | 0 | TNTC | TNTC | TNTC |
| Carvacrol | 0 | 0 | 0 | TNTC |
| Hinokitiol | 0 | 812 | TNTC | TNTC |

^{a}Number of colony forming units (CFU) in 100 μl sample.
^{b}TNTC = Too Numerous To Count.

All chitosan salts were effective inhibitors of E. coli growth at concentrations of 0.1%-0.0063%, but no effect was seen with concentrations of 0.0032% or lower (Table 4).

TABLE 4
Effect of Concentration of Chitosan Salts on
Growth of E. coli (CFU^{a})

| | Concentration (% v/v) | | | | | | |
|---|---|---|---|---|---|---|---|
| | 0.1 | 0.05 | 0.025 | 0.0125 | 0.0063 | 0.0032 | 0.0016 |
| Chitosan- | 0 | 0 | 1 | 0 | 0 | TNTC | TNTC |
| acetate | | | | | | | |
| Chitosan- | 0 | 0.5 | 0.5 | 0 | 26 | TNTC | TNTC |
| propionate | | | | | | | |
| Chitosan- | 0 | 0 | 0 | 0 | 4.5 | TNTC | TNTC |
| sorbate | | | | | | | |

^{a}Number of colony forming units (CFU) in 100 μl sample.
^{b}TNTC = Too Numerous To Count.

Essential oils and chitosan salts, each at concentrations shown to be non-inhibitory in Tables 3 and 4, were combined with E. coli as described above and their effectiveness at inhibiting the growth of E. coli was measured. All combinations inhibited E. coli growth (Table 5). The individual essential oils and chitosan salts acted synergistically in combination; each inhibited in combination at concentrations where they were not individually inhibitory. Those essential oils that were found to be the least effective inhibitors of E. coli growth, as shown in Table 3, were effective inhibitors when tested together with chitosan salts.

TABLE 5
Effect of Synergistic Combinations of Essential Oils and
Chitosan Salts on Growth of E. coli (CFU^{a})

| | | Concentration (% v/v) | | | |
|---|---|---|---|---|---|
| | | Chitosan | Chitosan | Chitosan | |
| | | acetate | propionate | sorbate | |
| | Conc. (%) | 0.0032 | 0.0032 | 0.0032 | Water |
| Water | | TNTC | TNTC | TNTC | TNTC |
| Bay | 0.075 | 75 | 180 | 479 | TNTC |
| Cinnamon | 0.050 | 401 | 582 | 793 | TNTC |
| Savory | 0.025 | 1803 | 691 | 1614 | TNTC |
| Thyme Red | 0.025 | 1044 | 115 | 1328 | TNTC |
| Allspice | 0.075 | 0 | 20 | 32 | TNTC |
| Birch | 0.075 | 640 | 1621 | 2713 | TNTC |
| Cloves | 0.075 | 34 | 83 | 193 | 1212 |
| Carvacrol | 0.025 | 0 | 0 | 2 | 1430 |
| Hinokitiol | 0.075 | 102 | 56 | 60 | 1108 |

^{a}Number of colony forming units (CFU) in 100 μl sample.
^{b}TNTC = Too Numerous To Count.

Spore germination of B. cinerea:

Similar results were observed when spore germination of B. cinerea was measured (Tables 6, 7, and 8). The individual essential oils: bay, cinnamon, allspice and cloves were inhibitory at 0.05%; savory and thyme red were inhibitory only at 0.1 % (Table 6). Thus, savory and thyme red, the most effective inhibitors of bacterial (E. Coli) growth were not as effective in inhibiting spore germination of the fungus, B. cinerea; bay, cinnamon, allspice and cloves were more effective.

TABLE 6
Effect of Concentration of Essential Oils on Spore Germination of B. cinerea.

| | Percent Inhibition of Spore Germination | | | | | | | | | |
|---|---|---|---|---|---|---|---|---|---|---|
| | Concentration (% v/v) | | | | | | | | | |
| | 0.1 | 0.09 | 0.08 | 0.07 | 0.06 | 0.05 | 0.04 | 0.03 | 0.02 | 0.01 |
| Bay | 100 | 100 | 100 | 100 | 100 | 100 | 0 | 0 | 0 | 0 |
| Cinnamon | 100 | 100 | 100 | 100 | 100 | 100 | 0 | 0 | 0 | 0 |
| Savory | 100 | 0 | 0 | 0 | 0 | 0 | 0 | 0 | 0 | 0 |
| Thyme Red | 100 | 0 | 0 | 0 | 0 | 0 | 0 | 0 | 0 | 0 |
| Allspice | 100 | 100 | 100 | 100 | 100 | 100 | 0 | 0 | 0 | 0 |
| Cloves | 100 | 100 | 100 | 100 | 100 | 100 | 100 | 0 | 0 | 0 |

Chitosan-sorbate alone was effective in completely inhibiting B. cinerea spore germination at concentrations of 0.1% to 0.0175% (Table 7). Complete inhibition of spore germination of B. cinerea was obtained with chitosan-acetate and chitosan-propionate at 0.1% and 0.08%.

TABLE 7
Effect of Concentrations of Chitosan Salts on
Spore Germination of B. cinerea.

| | Percent Inhibition of Spore Germination | | | | | | | |
|---|---|---|---|---|---|---|---|---|
| | Concentration (% v/v) | | | | | | | |
| | 0.1 | 0.08 | 0.06 | 0.04 | 0.02 | 0.0175 | 0.015 | 0.0125 |
| Chitosan- | 100 | 100 | 0 | 0 | 0 | 0 | 0 | 0 |
| acetate | | | | | | | | |
| Chitosan- | 100 | 100 | 0 | 0 | 0 | 0 | 0 | 0 |
| propionate | | | | | | | | |
| Chitosan- | 100 | 100 | 100 | 100 | 100 | 100 | 0 | 0 |
| sorbate | | | | | | | | |

Essential oils and chitosan salts, each at concentrations shown to be non-inhibitory in Tables 6 and 7, were combined with B. cinerea, as described above, and their effectiveness at inhibiting spore germination of B. cinerea was measured. All combinations of essential oils and chitosan salts, at concentrations where they were not individually inhibitory, showed a synergistic effect and completely inhibited B. cinerea spore germination (Table 8). Those essential oils that were found to be the least and the most effective inhibitors of B. cinerea spore germination (Table 6) were equally effective when tested together with chitosan salts even though both the essential oil and the chitosan salt were present at concentrations where no inhibition had previously been observed (Tables 6 and 7).

TABLE 8
Effect of Synergistic Combinations of Essential Oils
and Chitosan Salts on Spore Germination of B. cinerea.

| | | Percent Inhibition of Spore Germination | | | |
|---|---|---|---|---|---|
| | | Concentration (% v/v) | | | |
| | | Chitosan | Chitosan | Chitosan | |
| | Conc. | acetate | propionate | sorbate | |
| | % (v/v) | 0.02 | 0.02 | 0.006 | Water |
| Bay | 0.013 | 100 | 100 | 100 | 0 |
| Cinnamon | 0.013 | 100 | 100 | 100 | 0 |
| Savory | 0.03 | 100 | 100 | 100 | 0 |
| Thyme Red | 0.03 | 100 | 100 | 100 | 0 |
| Allspice | 0.02 | 100 | 100 | 100 | 0 |
| Cloves | 0.01 | 100 | 100 | 100 | 0 |
| Hinokitiol | 0.067 | 100 | 100 | 100 | 0 |

### Example 4

### Effect of Combinations of Chitosan Salts and Essential Oils on E. coli 015:H7 and L. monocytogenes.

To determine whether the combinations of essential oils and chitosan salts that were shown in Examples 1-3 to be effective inhibitors of growth of the non-pathogenic indicator strain of E. coli would also effectively inhibit pathogenic bacteria, the most promising combinations were tested at the USDA ARS Eastern Regional Research Center (Wyndmoor, Pa.) for their effectiveness in inhibiting the growth of the pathogenic bacteria L. monocytogenes and E. coli 01 5:H7, a strain of E. coli pathogenic to humans. Autoclaved LB was amended with a sterile solution of the combination of chitosan-sorbate with cinnamon oil, chitosan-sorbate with allspice, chitosan-propionate with red thyme, or chitosan-sorbate with savory to obtain a final concentration of 0.1 % (v/v). Test tube cultures were inoculated with 10⁶ CFU per ml of E. coli 0157:H7 or L. monocytogenes and incubated on a rotary shaker at 240 C. An individual test tube served as one replicate and four replicates were sampled after 0, 1, 2, and 24 hr of incubation from each treatment for each bacteria. The viable bacterial cell number was counted by surface plating serially diluted samples containing E. coli 015:H7 and L. monocytogenes in triplicate on LB agar medium and lithium chloride-phenylethanol-moxalactan agar, respectively. Plates were incubated at 24° C. and colonies were counted after 48 hr.

From these tests, it is apparent that all four combinations of the essential oils and chitosan salts were effective in inhibiting the growth of E. coli strain 01 57:H7 and L. monocytogenes (Table 9).

TABLE 9
Biocidal activity of different combinations of natural compounds and essential oils
on growth of E. coli 0157:H7 and L. monocytogenes cells after 0, 1, 4, and 24 hr.

| | Bacterial Cell Counts (Log CFU)^{a} | | | | | | | |
|---|---|---|---|---|---|---|---|---|
| | E. coli 0157:H7 | | | | L. monocytogenes | | | |
| TREATMENTS | 0 hr | 1 hr | 4 hr | 24 hr | 0 hr | 1 hr | 4 hr | 24 hr |
| Control | 6 | 6 | 6 | 6 | 6 | 6 | 6 | 6 |
| Chitosan sorbate + Cinnamon | 6 | 6 | 6 | 0 | 3 | 0 | 0 | 0 |
| Chitosan sorbate + Allspice | 6 | 6 | 6 | 0 | 3 | 0 | 0 | 0 |
| Chitosan propionate + Red Thyme | 6 | 6 | 0 | 0 | 0 | 0 | 0 | 0 |
| Chitosan propionate + Savory | 0 | 0 | 0 | 0 | 0 | 0 | 0 | 0 |

^{a}Number of Colony Forming Units (CFU) in 100 ml sample expressed in Log CFU/ml.

### Example 5

### Effect of Essential Oils and Chitosan Salts on Contamination of Apple Disk with E. coli.

Experiments were conducted to determine whether cinnamon, allspice, savory, chitosan sorbate, and chitosan propionate and/or their combinations could protect fruit surfaces against colonization by E. coli and whether E. coli could be eradicated once established on fruit surfaces with these treatments. Tree-ripe apples (Malus domestica Borkh) cultivar ‘Red delicious’ were hand-picked at harvest maturity at the Appalachian Fruit Research Station, Kearneysville, W. Va. Fruit were sorted to remove any with apparent injuries or infections and stored at 4° C. under refrigeration before being used in the biocontrol tests. Apple disks (10 mm) were excised from selected Red delicious apples using a cork borer. Apple disks were treated by immersion for 90 min in a 0.1% solution of various essential oils and/or their combinations with 0.1 % chitosan salts. Disks were either treated with the different combinations of natural compounds and then inoculated with E. coli by soaking apple disks in a solution of E. coli for 90 min or inoculated with E. coli and incubated at 24° C. for 24 hr. From each treatment four disks were selected randomly, individually homogenized in 5 ml of sterile water, vortexed, and dilution plated in triplicate on a LB agar medium. Plates were incubated at 24° C. and colonies were counted after 48 hr.

Chitosan sorbate and chitosan propionate in combination with essential oils of cinnamon, allspice, and savory completely protected apple disks against colonization by E. coli and completely eradicated established E. coli growth (Table 10).

TABLE 10
Protectant and Eradicant Effects of Natural Compounds
on Growth of E. coli on Apple Disks.

| | Protectant Activity^{a} | Eradicant Activity^{b} |
|---|---|---|
| TREATMENTS^{e} | E. coli (CFU)^{c} | E. coli (CFU) |
| Control | ^{TNTC}^{d} | TNTC |
| Sorbate | TNTC | TNTC |
| Propionate | TNTC | TNTC |
| Chitosan sorbate | 133 | 248 |
| Chitosan propionate | >1800 | >1800 |
| Cinnamon | 43 | 450 |
| Allspice | >1800 | 548 |
| Savory | 41 | 54 |
| Chitosan sorbate + Cinnamon | 0 | 0 |
| Chitosan sorbate + Allspice | 0 | 0 |
| Chitosan propionate + Savory | 0 | 0 |

^{a}Apple disks were treated with the different combinations and thereafter immersed in 3 ml aqueous solution containing 10⁶ CFU per ml of E. coli for 90 min.
^{b}Apple disks were immersed in 3 ml aqueous solution containing 10⁶ CFU per ml of E. coli for 90 min, drained, and treated with the different combinations.
^{c}Number of colony forming units (CFU) in 100 ml sample.
^{d}TNTC = Too Numerous To Count.
^{e}All essential oils and chitosan salts were tested at 0.1% (v/v).

All publications and patents mentioned in this specification are herein incorporated by reference to the same extent as if each individual publication or patent was specifically and individually indicated to be incorporated by reference.

It is understood that the foregoing detailed description is given merely by way of illustration and that modifications and variations may be made therein without departing from the spirit and scope of the invention.

We claim:

1. A composition having antibacterial and antifungal properties comprising a chitosan salt and an essential oil.

2. A composition having antibacterial and antifungal properties comprising a chitosan salt and an essential oil in a synergistically effective amount.

3. A composition according to claim 1 wherein said composition further comprises a surface-active agent.

4. A composition according to claim 1, wherein said essential oil is selected from the group consisting of cinnamon, savory, red thyme, allspice, bay, birch, cloves, carvacrol, and hinokitiol and mixtures thereof.

5. A composition according to claim 1 wherein said composition further comprises an additional antimicrobial ingredient.

6. A composition according to claim 1 wherein said composition further comprises at least an optional ingredient selected from the group consisting of protective colloids, adhesives, binding agents, chelating agents, thickening agents, thixotropic agents, penetrating agents, stabilizing agents, sequestering agents, anti-foam agents, antioxidants, natural or synthetic seasonings and/or flavors, dyes and/or colorants, vitamins, minerals, nutrients, enzymes, insecticides, deodorants, and mixtures thereof.

7. A wipe impregnated with the antibacterial and antifungal composition according to claim 1.

8. A composition according to claim 1, packaged in a spray dispenser.

9. A packaging material impregnated with the composition of claim 1.

10. A method for treating a surface of a food product wherein a composition according to claim 1 is applied onto said surface.

11. A method for protecting food products from bacterial and fungal infection by contacting the surface of a fruit or vegetable with the composition according to claim 1.

12. A method for protecting an exposed fresh fruit or an exposed fresh vegetable from postharvest and foodborne pathogens, the method comprising:
a) applying the composition of claim 1 to the surface of a fresh fruit or fresh vegetable; and
b) obtaining a fresh fruit or fresh vegetable that is protected from postharvest and foodborne pathogens.

13. The method according to claim 12 wherein said composition is directly applied to said food surface.

14. The method according to claim 13 wherein said composition is directly applied to said food surface by means of being included in a marinade, breading, seasoning rub, glaze or colorant mixture which is applied to said food surface.

15. The method according to claim 12 wherein said composition is applied to food packaging material which is thereafter brought into contact with said food surface.

16. A method for inhibiting microbial growth or toxin production in foods contaminated with bacteria and fungi by contacting the surface of a fruit or vegetable with the composition according to claim 1.

17. A method for reducing the overall bacterial and fungal content of a food product by applying to the surface of said product an effective amount of the composition of claim 1.

18. The method according to claim 17 wherein said food product is a fruit, vegetable, or edible nut.

19. A food product having reduced bacteria or fungi as a result of having applied thereon to its surface a composition which demonstrates efficacy against bacteria or fungi or both, comprising the composition of claim 1.

20. An exposed fresh fruit or vegetable or a mixture of exposed fresh fruits and vegetables, comprising: cut pieces of fruit or vegetable; and a coating on the exposed surfaces of the fruit or vegetable, the coating comprising the composition of claim 1.
